(19) United States
(12) Patent Application Publication
(10) Pub. No.: US 2008/0104588 A1
(43) Pub. Date: May 1, 2008

(54) Creation of temporary virtual machine clones of multiple operating systems

(76) Inventors: Michael J. Barber, Fort Collins, CO (US); Deborah J. Ogden, Fort Collins, CO (US); Alan Aspinwall, Fort Collins, CO (US); Judy Wathen, Fort Collins, CO (US); Ian A. Elliot, Fort Collins, CO (US); Robert Campbell, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/589,707

(22) Filed: Oct. 27, 2006

(51) Int. Cl. G06F 9/455

(52) U.S. Cl. 718/1

(57) ABSTRACT

An embodiment of the invention provides an apparatus and method for creating operating systems for Virtual Machines. The apparatus and method perform acts including: cloning a guest operating system (OS) that is supported in a first Virtual Machine in order to create a cloned guest OS, and performing maintenance on the cloned guest OS, wherein the cloned guest OS is booted in a second Virtual Machine before performing maintenance on the cloned guest OS, or wherein maintenance is performed on the cloned guest OS and the cloned guest OS is then booted in the second Virtual Machine.

### TECHNICAL FIELD

Embodiments of the invention relate generally to creation of multiple operating system images for Virtual Machines.

### BACKGROUND

Updates are performed on operating systems so that they are modified to become current. The updates to the operating system will, for example, add new features to, update the versions of, add patches to, or perform other modifications or maintenance to the operating system. However, current operating systems such as, for example, the WINDOWS-based operating systems from MICROSOFT CORPORATION, the LINUX operating system, or the VMWARE SERVER 1.0 from VMWARE, INCORPORATED, permit updates to running systems, but has the risk in that the software to be updated may be in use. Using an OS while it is being updated can cause failures that are critical and difficult to troubleshoot. Furthermore, prior solutions for performing updates such as, for example, ALTERNATE ROOT DISK from IBM CORPORATION, LIVE UPGRADE from SUN MICROSYSTEMS, INCORORATED, and DPS from MICROSOFT CORPORATION do not permit updates to be performed across multiple types of operating systems and do not create a backup of an operating system within a Virtual Machine environment.

Therefore, the current technology is limited in its capabilities and suffers from at least the above constraints and deficiencies.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a block diagram of an apparatus (system) in accordance with an embodiment of the invention.

FIG. 2 is a flow diagram of a method in accordance with an embodiment of the invention.

### DETAILED DESCRIPTION OF PREFERRED EMBODIMENTS

In the description herein, numerous specific details are provided, such as examples of components and/or methods, to provide a thorough understanding of embodiments of the invention. One skilled in the relevant art will recognize, however, that an embodiment of the invention can be practiced without one or more of the specific details, or with other apparatus, systems, methods, components, materials, parts, and/or the like. In other instances, well-known structures, materials, or operations are not shown or described in detail to avoid obscuring aspects of embodiments of the invention.

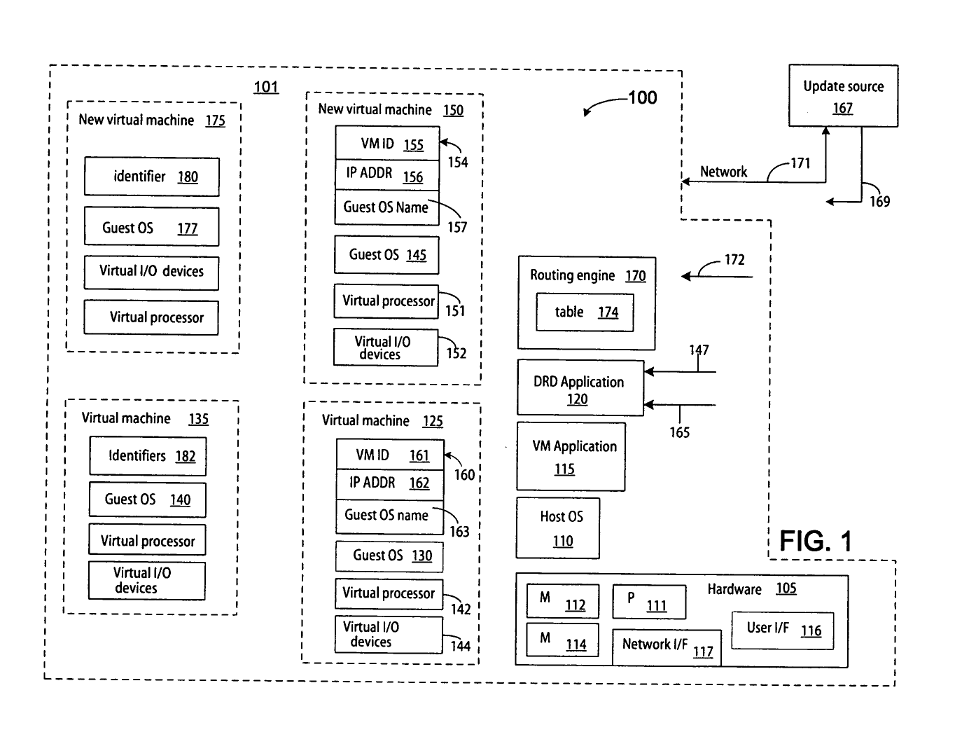

FIG. 1 is a block diagram of an apparatus (system) 100 in accordance with an embodiment of the invention. The apparatus 100 is typically implemented in a computing device 101 such as, for example, a server or any other suitable computing device. As discussed below, the apparatus 100 permits creating temporary virtual machine clones of multiple operating systems, and maintenance could then be performed on the clones with minimal downtime for the VMs in the apparatus 100. The maintenance operations will update the clones and these updated clones can then take over the functions of the original operating systems. The apparatus 100 includes a hardware layer 105 that operates with a host operating system (host OS) 110. As known to those skilled in the art, the hardware layer 105 typically includes one or more processors like 111 (which can have one or more processing cores), memory devices (e.g., memory devices 112 and 114), input/output devices, file storage devices, user interface 116, network interface 117, and/or other components that permit computing operations to be performed. Other components that are known to those skilled in the art are not shown in the hardware layer 105 for purposes of achieving clarity in the drawings.

A virtual machine (VM) application 115 runs on the host OS 110. The virtual machine application 115 may be, for example, the HP INTEGRITY VIRTUAL MACHINE which is commercially available from HEWLETT-PACKARD COMPANY, Palo Alto, Calif. The host OS 110 can be, for example, an operating system in the HPUX operating system family which is provided by Hewlett-Packard Company.

When the VM application 115 runs on the host OS 110, the VM application 115 provides one or more Virtual Machines. Additionally, a DRD (Dynamic Root Disk) application 120 can clone an original guest operating system that is running in a Virtual Machine and then perform updates or maintenance on the cloned guest operating system to be booted in a newly-started Virtual Machine, while the original guest operating system concurrently runs in its own Virtual Machine, in accordance with an alternative set of operations. Typically, the VM application 115 will start the new Virtual Machines. The DRD application 120 clones one or more different operating system types that are supported in the Virtual Machines and updates or modifies the cloned operating systems while the cloned operating systems are inactive OS images and before the updated cloned operating systems are changed in their identities and booted in the new Virtual Machines, in accordance with an alternative set of operations. The DRD application 120 can, for example, be a separate software code and/or component, or can be software code and/or component that are integrated within the VM application 115 or host OS 110. Therefore, the VM application 115 or host OS 110 can be modified so that they perform the functions of the DRD application 120 that are discussed in detail below. Those skilled in the art will realize based upon the reading of this disclosure that the features of the DRD application 120 can be implemented in various manners in the apparatus 100.

As known to those skilled in the art, a Virtual Machine describes specific programs that mimic a computer within a computer, or a simulation of a physical device represented by computer software. Virtual Machines permit multiple operating systems and programs to be run by the computer at the same time, and each user appears to have an independent computer with its own input and output devices. A Virtual Machine permits an operating system type to run on a processor that has been designed to run another different operating system type. Virtual Machines have been described in, for example, commonly-owned U.S. patent application Ser. No. 10/175,183, entitled “Multiple Trusted Computing Environments With Verifiable Environment Identities” which is hereby incorporated herein by reference.

The VM application 115 provides one or more Virtual Machines that supports a guest operating system that can be of a different type from the host OS 110. For example, the Virtual Machine 125 supports a guest OS 130 which may be a different type from the host OS 110. For example, the host OS 110 can be an HP-UX family operating system type, while the guest OS 130 can be a different operating system type (e.g., Windows family operating system). The VM application 115 can provide a variable number of Virtual Machines. For example, the VM application also provides another Virtual Machine 135 that supports another guest OS 140. That second guest OS 140 may be of a different type from the host OS 110 and the first guest OS 130 (e.g., the second guest OS 140 may be a LINUX, AIX (Advance Interactive executive or Advanced IBM UNIX), SOLARIS, or another OS type). A Virtual Machine will simulate hardware, so that processes (e.g., applications) can run on a guest OS in the Virtual Machine, even if the guest OS is not designed to be run on the processor 111 in the hardware layer 105. As a result, the Virtual Machines permit the apparatus 100 to concurrently support multiple-different types of operating systems.

A Virtual Machine is allocated a specified amount of memory in the hardware layer 105, a virtual processor having one or more virtual CPUs (or cores), and a set of virtual I/O devices. For example, in FIG. 1, the Virtual Machine 125 is allocated the virtual processor 142 and the virtual I/O devices 144. Each Virtual Machine typically hosts its own applications in a fully isolated environment. Multiple Virtual Machines can share the underlying physical resources of the hardware layer 105 of a computing device 101 that hosts the Virtual Machines. For example, multiple Virtual Machines can share the processor 111. Furthermore, a single Virtual Machine can contain multiple virtual resources, where each virtual resource is associated with an underlying physical resource. For example, the Virtual Machine 125 contains the virtual processor 142 and virtual I/O devices 144, and these virtual resources are associated with physical resources in the hardware layer 105.

The DRD application 120 runs on the host OS 110. In an embodiment of the invention, the DRD application 120 will clone (copy) a guest OS 130 in order to create a cloned guest OS 145 that can be maintained or updated while the original guest OS 130 continues to run. The DRD application 120 copies the root disks and other data of the guest OS 130 in order to create the cloned guest OS 145. The DRD application 120 will clone the guest OS 130 from data in the memory area 112 which maps the guest OS 130. The DRD application 120 will then map the cloned OS 145 in the memory area 114. As an example, the memory areas 112 and 114 may each be a disk or another suitable type of memory device in the hardware layer 105. The cloned guest OS 145 is an image of the original guest OS 130 when the cloned guest OS 145 is originally created by the DRD application 120, and will vary from the original guest OS 130 when the DRD application 120 subsequently updates the cloned guest OS 145 in accordance with one alternative set of operations. The DRD application 120 clones a guest OS in response to a DRD clone command 147 sent via the user interface 116 from a system administrator or other user. In another alternative set of operations, the updated cloned guest OS 145 is then booted in a new Virtual Machine, then the cloned guest OS 145 is updated by tools typically used to perform software maintenance on original guest OS 130.

In an embodiment of the invention, after the DRD application 120 clones the original guest OS 130, the DRD application 120 will change the identity of the cloned guest OS 145, and the VM application 115 will then boot the cloned guest OS 145 in a new Virtual Machine 150. The DRD application 120 causes the VM application 115 to start the new Virtual Machine 150 which typically will be mapped to the memory device 114. The new Virtual Machine 150 will also have a virtual processor 151 and virtual I/O device 152.

Software maintenance tools for that OS can then be used to performs software maintenance (updates) on the cloned guest OS 145. The routing engine 170 then allows the updated guest OS 145 in the new Virtual Machine 150 to take over the functions of the original guest OS 130. Further details of these steps are discussed further below.

Alternatively, after the DRD application 120 clones the original guest OS 130, the DRD application 120 will instead perform software maintenance (updates) on the cloned guest OS 145 which is currently an inactive operating system image that is a clone of the original guest OS 130. The DRD application 120 will then change the identity of the updated cloned guest OS 145, and the VM application 115 will then boot the updated cloned guest OS 145 in a new Virtual Machine 150. The routing engine 170 then allows the updated guest OS 145 in the new Virtual Machine 150 to take over the functions of the original guest OS 130.

In both alternatives, the DRD application-120 will change the identity 154 of the cloned guest OS 145 so that the identity 154 is different from the identity 160 of the original guest OS 130. For example, the identity 154 includes the Virtual Machine identifier 155 of the Virtual Machine which runs the cloned guest OS 145, the virtual Internet Protocol address 156 of the new Virtual Machine 150, and the guest OS name 157 of the cloned guest OS 145. Note that the identity 160 of the original guest OS 130 also includes a Virtual Machine identifier 161, the virtual Internet Protocol address 162, and guest OS name 163.

In an embodiment of the invention, the contents of cloned guest OS 145 (including the root disks) are modified or updated, without impacting the original guest OS 130 which can continue to run in the original Virtual Machine 125 while the cloned guest OS 145 is concurrently modified or updated. Software for the cloned guest OS 145 is updated by updating or modifying data in the memory area 114 which maps the cloned guest OS 145. In one alternative, the DRD application 120 updates or modifies to the cloned guest OS 145, in response to a DRD run command 165 sent via the user interface 117 from a system administrator or other user. A DRD run command executes a software management command on the software in a cloned (inactive) system image.

An update source 167, which may be a node coupled via a communications network 171 to the apparatus 100, or may be local files in the host OS or a VM, sends the updates 169 that will update or modify the cloned guest OS 145. For example, the update source 167 sends patches, service packs, new software versions, or other types of updates that will update or modify the cloned guest OS 145. These updates 169 will modify the data in the memory area 114 which maps the cloned guest OS 145. The type of updates 169 that modifies or updates the cloned guest OS 145 is dependent on the operating system type of the cloned guest OS 145.

When used to modify the OS on an inactive system image, the DRD application 120 can update the cloned guest OS 145 while the guest OS 130 concurrently runs in the original Virtual Machine 125, and the updates to the cloned guest OS 145 will not impact the concurrently running original guest OS 130.

Alternatively, if the cloned guest OS 145 is updated, after the cloned guest OS 145 is booted in the new Virtual Machine 150, the updates to the cloned guest OS 145 can be done using software maintenance tools for that OS and will also not impact the original guest OS 130 which is concurrently running in the Virtual Machine 125.

With either alternative, once the updates or maintenance that are performed on the cloned guest OS 145 are acceptable to a system administrator, and once the new VM has it's own identity, the routing engine 170 will route all data traffic 172 that is intended for transmission to the original guest OS 130 to the updated guest OS 145. The data traffic 172 can be, for example, requests, function calls, or other types of data transmissions that is to be processed by an operating system.

As an example, the routing engine 170 can have a translation table 174 that permits the routing engine 170 to route all data traffic 172 intended for transmission to the original guest OS 130 to the updated guest OS 145. The routing engine 170 can use other suitable methods for routing data traffic 172 intended for the original guest OS 130 to the updated guest OS 145. The routing engine 170 can, for example, be a separate software code and/or component, or can be software code and/or component that is integrated with the VM application 115, host OS 110, or DRD application 120. Those skilled in the art will realize based upon the reading of this disclosure that the features of the routing engine 170 can be implemented in various manners in the apparatus 100.

The routing engine 170 can also bring offline, disconnect from receiving the traffic 172, and/or delete the original Virtual Machine 125 and original guest OS 130, when the routing engine 170 starts forwarding traffic 172 intended for the original guest OS 130 to the updated guest OS 145. The routing engine 170 can make the modification to the data in the memory area 112 which maps the original Virtual Machine 125 and original guest OS 130, so that the Virtual Machine 125 is brought offline, disconnected from receiving the traffic 172, and/or deleted.

The DRD application 120 can also clone one or more additional guest OS 140 in the Virtual Machine 135. The additional guest OS 140 may be a different operating system type from the guest OS 130 in the Virtual Machine 125. The DRD application 120 will cause the VM application 120 to create or start a new Virtual Machine 175 which will support the cloned guest OS 177 which is the clone of the original guest OS 140. The DRD application 120 can also assign an identity 180 for the cloned guest OS 177. The identity 180 will be different from the identity 182 of the original guest OS 140 in the Virtual Machine 135. Tools used to software maintenance for that OS can update or modify the cloned guest OS 177 in the new Virtual Machine 175 while the original guest OS 140 concurrently runs in the original Virtual Machine 135, as similarly discussed above.

Alternatively, DRD 120 can be used to update the cloned guest OS 177 when the guest OS 177 is inactive, and the updated cloned guest OS 177 is then changed to the identity 180 and is then booted in the new Virtual Machine 175, and the updates to the cloned guest OS 177 will also not impact the original guest OS 140 which is concurrently running in the Virtual Machine 135.

When the cloned guest OS 177 has been updated or modified and the identity changed, the routing engine 170 can then forward data traffic 172 intended for the original guest OS 140 to the updated guest OS 177. The routing engine 170 can also bring offline, disconnect from receiving traffic 172, and/or delete the original Virtual Machine 135 and original guest OS 140 in a manner as similarly discussed above. Therefore, embodiments of the invention permit a system administrator to update or maintain multiple different types of operating systems (e.g., guest OS 130 and guest OS 140 which are different operating system types) by cloning the original operating systems and updating the cloned operating systems, without impacting the original operating systems that can concurrently run in the original Virtual Machines.

These cloned operating system images can be used for maintenance (i.e., updates) and/or safety failover (i.e., if the original guest OS 130 fails, then the routing engine 170 can route the traffic 172 to the cloned guest OS 145 which will take over the functions of the failed guest OS 130). The DRD application 120 advantageously reduces the system down time for information technology systems by allowing system administrators to update and maintain the system (even during peak times) without affecting the running original operating system. Also, embodiments of the invention advantageously allow a system administrator to support, manage, or update different types of operating systems that are supported in the Virtual Machines. In contrast, previous solutions that perform cloning (e.g., IBM Alternate Root Disk, Sun Live Upgrade, Symantec Norton Ghost, and Microsoft DPS) are only used to back up their respective host operating system, and do not have the capability to clone multiple different types of operating system images within a Virtual Machine.

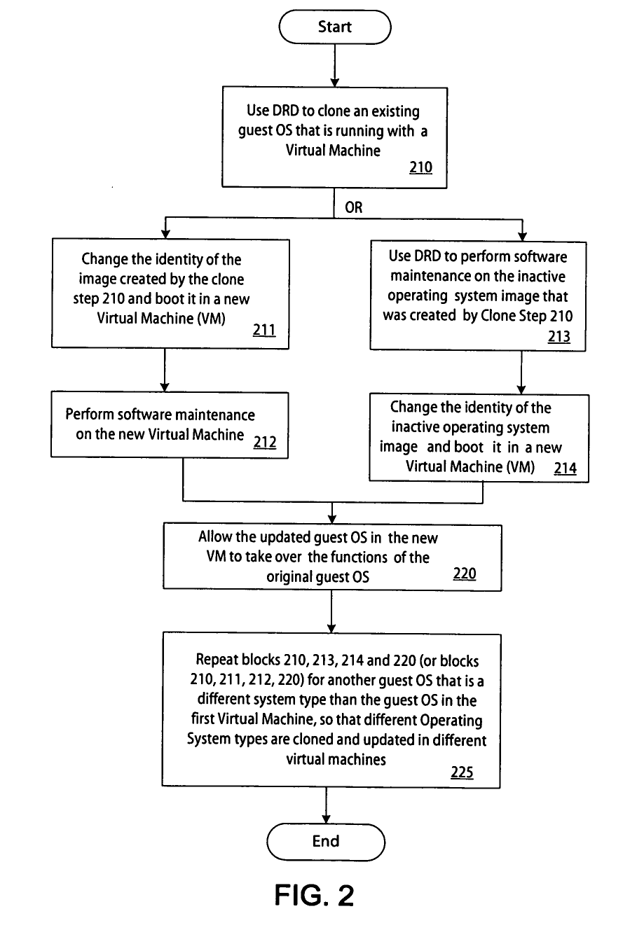

FIG. 2 is a flow diagram of a method 200 in accordance with an embodiment of the invention.

In block 210, the DRD 120 is used to clone an existing guest OS that is running in a first Virtual Machine (VM).

Either block 213 or block 211 is then performed. If block 213 is performed, then the DRD 120 is used to perform software maintenance (i.e., updates) on an inactive operating system image that was created by the clone step in block 210. This inactive operating system image is the clone of the existing guest OS in the first Virtual Machine, and this image is not yet running in a virtual machine. In block 214, the identity of the inactive operating system image is changed, and the image is then booted in a new Virtual Machine.

Alternatively, after performing the steps in block 210, if block 211 is performed, then the identity of the operating system image that was created by the clone step in block 210 is changed, and the image is then booted in a new Virtual Machine. In block 212, software maintenance is performed on the new Virtual Machine. This step involves performing software maintenance on the image that is running in the new Virtual Machine.

After the steps in block 212 (or in block 214) are performed, in block 220, the updated guest OS (i.e., the updated image) in the new Virtual Machine is allowed to take over the functions of the original guest OS that was previously cloned in block 210.

In block 225, the steps are repeated in blocks 210, 213, 214, and 220 (or the steps are repeated in block 210, 211, 212, and 220) for another guest OS that is a different operating system type than the original guest OS type that was running in the first Virtual Machine. Therefore, different operating system types can be cloned and updated in different Virtual Machines.

It is also within the scope of the present invention to implement a program or code that can be stored in a machine-readable or computer-readable medium to permit a computer to perform any of the inventive techniques described above, or a program or code that can be stored in an article of manufacture that includes a computer readable medium on which computer-readable instructions for carrying out embodiments of the inventive techniques are stored. Other variations and modifications of the above-described embodiments and methods are possible in light of the teaching discussed herein.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. A method of creating operating systems for Virtual Machines, the method comprising:
cloning a guest operating system (OS) that is supported in a first Virtual Machine in order to create a cloned guest OS; and
performing maintenance on the cloned guest OS, wherein the cloned guest OS is booted in a second Virtual Machine before performing maintenance on the cloned guest OS, or wherein maintenance is performed on the cloned guest OS and the cloned guest OS is then booted in the second Virtual Machine.

2. The method of claim 1, further comprising:
allowing an updated cloned guest OS in the second Virtual Machine to take over the functions of the guest OS in the first Virtual Machine, and disconnecting the first Virtual Machine.

3. The method of claim 1, further comprising;
routing all traffic intended for the guest OS to the updated cloned guest OS.

4. The method of claim 1, further comprising:
changing an identity of the cloned guest OS to be different from an identity of the guest OS.

5. The method of claim 1, further comprising:
cloning a second guest OS that is supported in a third Virtual Machine in order to create a second cloned guest OS; and
performing maintenance on the second cloned guest OS, wherein the second cloned guest OS is booted in a fourth Virtual Machine before performing maintenance on the second cloned guest OS, or wherein maintenance is performed on the second cloned guest OS and the second cloned guest OS is then booted in the fourth Virtual Machine.

6. The method of claim 5, further comprising:
allowing an updated second cloned guest OS in the fourth Virtual Machine to take over the functions of the second guest OS in the third Virtual Machine, and disconnecting the third Virtual Machine.

7. The method of claim 5, further comprising;
routing all traffic intended for the second guest OS to the updated second cloned guest OS.

8. The method of claim 5, further comprising:
changing an identity of the second cloned guest OS to be different from an identity of the second guest OS.

9. The method of claim 1, wherein the Virtual Machines are provided by a virtual machine application that runs on a host OS.

10. The method of claim 1, wherein the Virtual Machines share physical resources in a computing device.

11. An apparatus for creating operating systems for Virtual Machines, the apparatus comprising:
a virtual machine application configured to provide Virtual Machines;
a dynamic root disk (DRD) application configured to clone a guest operating system (OS) that is supported in a first Virtual Machine in order to create a cloned guest OS;
wherein the virtual machine application is configured to start a second Virtual Machine that will support the cloned guest OS; and
wherein the cloned guest OS is booted in a second Virtual Machine before performing maintenance on the cloned guest OS, or wherein the DRD performs maintenance on the cloned guest OS and the cloned guest OS is then booted in the second Virtual Machine.

12. The apparatus of claim 11, further comprising:
a routing engine configured to allow an updated cloned guest OS in the second Virtual Machine to take over the functions of the guest OS in the first Virtual Machine, and to disconnect the first Virtual Machine.

13. The apparatus of claim 12, wherein the routing engine is configured to route all traffic intended for the guest OS to the updated cloned guest OS.

14. The apparatus of claim 11, wherein the DRD application is configured to clone a second guest OS that is supported in a third Virtual Machine in order to create a second cloned guest OS;
wherein the virtual machine application is configured to start a fourth Virtual Machine that will support the second cloned guest OS; and
wherein the second cloned guest OS is booted in the fourth Virtual Machine before performing maintenance on the second cloned guest OS, or wherein the DRD application performs maintenance on the second cloned guest OS and the second cloned guest OS is then booted in the fourth Virtual Machine, so that multiple different types of operating systems can be updated.

15. The apparatus of claim 14, wherein the routing engine is configured to allow an updated second cloned guest OS in the fourth Virtual Machine to take over the functions of the second guest OS in the third Virtual Machine, and to disconnect the third Virtual Machine.

16. The apparatus of claim 14, wherein the routing engine is configured to route all traffic intended for the second guest OS to the updated second cloned guest OS.

17. The apparatus of claim 11, wherein the virtual machine application runs on a host OS.

18. The apparatus of claim 11, wherein the Virtual Machines share physical resources in a computing device.

19. An apparatus for creating operating systems for Virtual Machines, the apparatus comprising:
means for cloning a guest operating system (OS) that is supported in a first Virtual Machine in order to create a cloned guest OS;
means for starting a second Virtual Machine that will support the cloned guest OS; and
means for performing maintenance on the cloned guest OS, wherein the cloned guest OS is booted in the second Virtual Machine before performing maintenance on the cloned guest OS, or wherein maintenance is performed on the cloned guest OS and the cloned guest OS is then booted in the second Virtual Machine.

20. The apparatus of claim 19, further comprising:
means for allowing an updated cloned guest OS in the second Virtual Machine to take over the functions of the guest OS in the first Virtual Machine, and for disconnecting the first Virtual Machine.

21. The apparatus of claim 19 further comprising;
means for routing all traffic intended for the guest OS to the updated cloned guest OS.

22. The apparatus of claim 19, further comprising:
means for cloning a second guest OS that is supported in a third Virtual Machine in order to create a second cloned guest OS;
means for starting a fourth Virtual Machine that will support the cloned second guest OS; and
means for performing maintenance on the second cloned guest OS, wherein the second cloned guest OS is booted in the fourth Virtual Machine before performing maintenance on the second cloned guest OS, or wherein maintenance is performed on the second cloned guest OS and the second cloned guest OS is then booted in the fourth Virtual Machine, so that multiple different types of operating systems can be updated.

23. The apparatus of claim 22, further comprising:
means for allowing an updated second cloned guest OS in the fourth Virtual Machine to take over the functions of the second guest OS in the third Virtual Machine, and for disconnecting the third Virtual Machine.

24. The apparatus of claim 22, further comprising;
means for routing all traffic intended for the second guest OS to the updated second cloned guest OS.

25. An article of manufacture comprising:
a machine-readable medium having stored thereon instructions to:
clone a guest operating system (OS) that is supported in a first Virtual Machine in order to create a cloned guest OS;
start a second Virtual Machine that will support the cloned guest OS; and
perform maintenance on the cloned guest OS, wherein the cloned guest OS is booted in the second Virtual Machine before performing maintenance on the cloned guest OS, or wherein maintenance is performed on the cloned guest OS and the cloned guest OS is then booted in the second Virtual Machine.

26. The article of manufacture of claim 25, wherein the instructions allow an updated cloned guest OS in the second Virtual Machine to take over the functions of the guest OS in the first Virtual Machine, and disconnect the first Virtual Machine.

27. The article of manufacture of claim 25, wherein the instructions route all traffic intended for the guest OS to the updated cloned guest OS.

28. The article of manufacture of claim 25, wherein the instructions clone a second guest OS that is supported in a third Virtual Machine in order to create a second cloned guest OS, start a fourth Virtual Machine that will support the second cloned guest OS, and perform maintenance on the second cloned guest OS, wherein the second cloned guest OS is booted in a fourth Virtual Machine before performing maintenance on the second cloned guest OS, or wherein maintenance is-performed on the second cloned guest OS and the second cloned guest OS is then booted in the fourth Virtual Machine, so that multiple different types of operating systems can be updated.

29. The article of manufacture of claim 28, wherein the instructions allow an updated second cloned guest OS in the fourth Virtual Machine to take over the functions of the second guest OS in the third Virtual Machine, and disconnect the third Virtual Machine.

30. The article of manufacture of claim 28, wherein the instructions route all traffic intended for the second guest OS to the updated second cloned guest OS.
